(19) United States
(12) Patent Application Publication
(10) Pub. No.: US 2026/0327156 A1
(43) Pub. Date: Oct. 22, 2026

(54) BRUSH ON COATING

(71) Applicant: Addman Intermediate Holdings, LLC, Fort Myers, FL (US)

(72) Inventors: Youping Gao, Thousand Oaks, CA (US); Jonathan W. Pegues, Albuquerque, NM (US)

(21) Appl. No.: 19/529,946

(22) Filed: Feb. 4, 2026

Related U.S. Application Data
(60) Provisional application No. 63/753,516, filed on Feb. 4, 2025.

(51) Int. Cl. C04B 41/50; C04B 41/00; C04B 41/45

(52) U.S. Cl. CPC C04B 41/5071; C04B 41/0072; C04B 41/009; C04B 41/4539

(57) ABSTRACT

A storage stable brush on slurry coating for a high refractory temperature alloy object includes a silicon-based powder, an aromatic hydrocarbon solvent and an acrylate adhesive. The slurry, once applied, is baked on the part and need not be removed when being joined to another high temperature refractory alloy object. The slurry has particular utility in preventing oxidation at high temperatures in aviation and aerospace components.

### CROSS REFERENCE TO RELATED APPLICATION

This application is a nonprovisional application of, and claims priority to and the benefit of, co-pending U.S. Provisional Patent Application Ser. No. 63/753,516, filed on Feb. 4, 2025, the disclosure of which is hereby incorporated by reference in its entirety including the drawings.

### TECHNICAL FIELD

The present disclosure concerns coating compositions for coating refractory alloy objects. More particularly, the present disclosure concerns coating compositions for high temperature refractory alloy objects. Even more particularly, the present disclosure concerns brush on coatings for use with high temperature refractory alloy objects, including niobium C103 objects.

### BACKGROUND

As is known to those skilled in the art to which the present invention pertains, many aviation and aerospace high temperature refractory alloy components or objects are exposed to extreme climatic conditions. They are exposed to extreme heat, as well as vacuum atmospheric conditions in outer space. In manufacturing these components, it is well known that they oxidize under these extreme conditions, which is an impediment to their efficacy.

The art has developed coatings to address and overcome these issues. Today the standard coating is identified as R512E for use with niobium C103 components which is a major product for use in such environments.

R512E is a silicide slurry made of iron, chromium and silicon. R512E has the inherent ability to withstand extremely high temperatures of up to about 2650 °F. However, this slurry must be applied using vacuum slurry fusion deposition.

Since R512E, by its very nature is a ceramic, it inhibits the ability to form good joints in securing components to each other. If an R512E coated component or object needs to be joined to other components, it must be removed or otherwise scraped off.

To overcome this disadvantage, the prior art has taught various R512E variants. For example, in U.S. Patent Publication No. 2012/0282485, there is disclosed multiple niobium-based coatings utilizing the basic R512E composition. Additionally, the art has taught the use of silicon-titanium, chromium-silicide and iron-silicide coatings for use on pure niobium and niobium CB 702 alloy. However, such coatings require pack cementation for deposition.

Further, a combination of aluminum oxide (Al₂ O₃) and silicon oxide (SiO₂) has been proposed as a possible niobium C103 coating composition.

Yet, in each instance, the deployment and implementation of known coatings have disadvantages that need to be improved.

Moreover, with certain application objects, there is no rapid increase in temperature from approximately the ambient to upwards of 3000 °F or more. Rather, there is a warming which the component or object goes through over a period of time. However, it has been observed that there is a “pesting” effect, in which the niobium alloy experiences rapid disintegration occurring between temperatures of 1100 °F and approximately 1850 °F. Thus, the issue of oxidation becomes extremely critical.

Also, it is known that when high temperature refractory alloy parts are welded together, coated surfaces must have their coatings removed and must then be cleaned for the weld preparation since coating materials are not compatible with fusion welding processes. The after welded assembly cannot be subjected to the same elevated temperature coating. Similarly, if there are cracks in a coating, the need to repair can be costly both in time and dollars.

Thus, there exists a need for a coating composition to inhibit oxidation of a high temperature refractory alloy object, which can easily be applied locally to such objects to repair existing coatings or to coat previously uncoated areas, such as areas subjected to welding or other joining, and otherwise eliminate the need for additional re-coating.

### BRIEF SUMMARY

The present disclosure teaches a “brush on” coating which overcomes the deficiencies in the present art by providing a slurry which can be painted or brushed onto, inter alia, niobium C103 components and which does not require removal of the coating from high temperature refractory alloy components or objects when they are being joined or connected to other objects or components.

According to one aspect, the coating comprises a slurry mixture of an aromatic hydrocarbon solvent, a silicon powder thickening additive and an adhesive. Additional solvents and thickeners which are soluble in the aromatic solvent may be used herein.

According to another aspect, the coating composition is a solvent-silicide-adhesive-slurry which can be applied to a niobium C103 high temperature refractory alloy or other high temperature refractory alloy object either manually, by painting or brushing on, immersion in a bath of the slurry, spray coating the slurry or the like. The slurry is applied to an object at room temperature and dries thereon. Thereafter, optimally, the so-coated object is baked at elevated temperatures of up to about 1600 °C, e.g., at 1590 °C.

In addition to niobium C103, the brush on coating hereof can be used with other high temperature refractory alloys (including other niobium-based refractory alloys), such as a niobium-Tantalum-Molybdenum refractory alloy, Hafnium Carbide alloy, HIP niobium C103 alloy objects and the like.

For a more complete understanding of the present invention, reference is made to the following detailed description.

### BRIEF DESCRIPTION OF THE DRAWINGS

FIG. 1 is a series of photographs of a niobium C103 coupon having been coated with a first formulation of a slurry according to aspects of the present disclosure;

FIG. 2 is a series of photographs of a niobium C103 coupon having been coated with a second formulation of a slurry according to aspects of the present disclosure;

FIG. 3 is a microscopic photograph at 500× of the coupon of FIG. 1 showing the presence of the slurry after treatment;

FIG. 4 is a photograph at 1000× of the coupon of FIG. 1;

FIG. 5 is a schematic diagram of a first embodiment of a method of forming a coated object according to aspects of the present disclosure;

FIG. 6 is a schematic diagram of a second embodiment of a method of forming a coated object according to aspects of the present disclosure; and

FIG. 7 is a schematic diagram of a third embodiment of a method of forming a coated object according to aspects of the present disclosure.

### DETAILED DESCRIPTION

In accordance with the present disclosure a slurry coating composition is configured for application to a part, particularly a part formed of a niobium refractory alloy or other refractory alloy, which can be applied by any suitable method including brushing, painting, immersion, spraying and the like.

The coating generally comprises a mixture of: (a) a solvent, such as an aromatic hydrocarbon solvent; (b) a silicon powder, such as a silicide powder, a silica powder (e.g., fumed silica or fused silica), or the like and (c) an adhesive. Other powders, solvents and selected adjuvants, as detailed below, may be added to the solvent-silicon-adhesive mixture. It is understood that this and other compositions disclosed herein may be limited to the components specifically disclosed (optionally further including components that do not materially affect the fundamental nature of the composition) in some embodiments, or may include additional components not disclosed herein in other embodiments.

The aromatic hydrocarbon solvent contemplated for use herein is selected from the group consisting of benzene, toluene and xylene. Preferably, the aromatic solvent used herein is toluene.

The adhesive used herein may be, in various embodiments, an alkyl acrylate and, particularly isobutyl methacrylate. Other useful acrylates include methyl acrylate, ethyl acrylate, propyl acrylate, butyl acrylate, n-butyl acrylate, and the like.

In preparing a slurry according to one embodiment, the composition generally contains (a) from about 40 to about 55 percent, by weight, of the aromatic hydrocarbon solvent based on the entire weight of the composition; (b) from about 40 to about 55 percent by weight of the silicon powder based upon the entire weight of the composition and (c) from about 5 to about 20 percent, by weight of the adhesive or an adhesion promoter.

The slurry composition may include additional solvents in other embodiments, such as ketone solvents. Where used, the ketone solvent may generally comprise a C₁ to C₄ aliphatic ketone in one embodiment. Representative ketones which may be used herein include, for example, acetone, methyl ethyl ketone, diethyl ketone, and the like. Preferably, where used, the ketone is methylene ketone or methyl ethyl ketone.

The present composition may have additional powders admixed therewith and can be selected from the group consisting of chromium, ferrous iron, ferric iron and the like.

Where used, the additional powders are present in an amount ranging from about 20 to about 60 percent by weight based upon the entire weight of the composition in one embodiment. In such instance, the amount of the silicon powder may be reduced.

Other adjuvants which may be included are, for example, other acrylic adhesives, plasticizers and other components which are soluble in the aromatic solvent and which do not impair the efficacy of the slurry. When used, the amounts of the complementary components are reduced accordingly.

In various embodiments, the solvent(s) and the powder(s), including the silicon powder, may be selected such that some or all of the powder(s) are soluble or insoluble in the solvent(s).

The slurry, itself, is prepared by admixing the components together at room temperature in one embodiment. When applied to a niobium object, i.e., having at least an outer surface formed of a niobium alloy, the silicon and adhesive bind to the niobium and form a niobium-silicide coating on the object surface after drying. Optionally, after drying, the object can be heated up to a temperature of up to about 1600 °C, which may further dry and/or achieve removal of volatile components.

As noted above, the slurry may be prepared by admixing the components together at room temperature usually for about two to three hours or longer. The so-prepared slurry is a storage-stable silicide slurry which can be directly applied to the high temperature refractory alloy object without any further need of preparation of the object itself.

The coating composition is applied to an outer surface of a base object, which may be an aerospace part or other functional part, and then dried or otherwise solidified to form a coated part including the base object and a coating. The coating may cover at least a portion of the base object, i.e., covering a portion or the entirety of the base object. The base object may be at least partially formed of a niobium refractory alloy or other high temperature refractory alloy, in various embodiments. The alloy may be niobium C103 in one embodiment, which is a niobium-based alloy including about 10 wt. % Hf (e.g., 9 to 11% Hf) and about 1 wt. % Ti or 0.7 to 1.3 wt. % Ti, and which may also include one or more of Zr (up to about 0.7%), W (up to about 0.5%), and Ta (up to about 0.5%), as well as potentially other elements and impurities in smaller amounts (e.g., up to 0.05 wt %). In other embodiments, the base object may have at least an outer portion formed of another niobium-based refractory alloys, such as a niobium-tantalum-molybdenum refractory alloy, or a different type of refractory alloy, such as a hafnium carbide alloy. The base object may be primarily or entirely a high-temperature refractory alloy in one embodiment, or may have a core (e.g., of a different refractory alloy or other material) with the refractory alloy disposed on or around at least a portion of the core. In one embodiment, the base object may be formed using an additive manufacturing technique, including various powder-based techniques, and may be subjected to hot isostatic pressing (HIP), e.g., to remove voids and/or densify the material, such as disclosed in U.S. Patent Application Publication No. US 2024/0335881, which is incorporated by reference herein in its entirety. It is understood that the base object may also be formed by joining two or more pieces, at least one of which may be formed by such techniques. The coating may be applied, using techniques disclosed herein, after manufacturing of the base object (including HIP if used) is complete in one embodiment.

The coating disclosed herein may be applied to cover at least a portion of the base object. The base object may also have a preexisting coating prior to application of the coating disclosed herein, which may be similar to or different from the coating disclosed herein. In one embodiment, the coating disclosed herein may be applied at least partially onto the preexisting coating. In another embodiment, the preexisting coating may be an incomplete coating, e.g., by not coating the base object completely or removing a portion of the preexisting coating. In this embodiment, the coating disclosed herein may be applied to the uncoated portion of the base object, i.e., either only to the uncoated portion or to at least some of both the coated and uncoated portions, or may be applied only to the coated portion. Such a coating may partially or completely cover the uncoated portion in one embodiment. One example of a preexisting coating is a disilicide coating or other silicide coating, and in one embodiment, the coating may be a disilicide coating or other silicide coating applied to an object with such a preexisting coating. In another embodiment, the coating may be applied to a base object that has no preexisting coating.

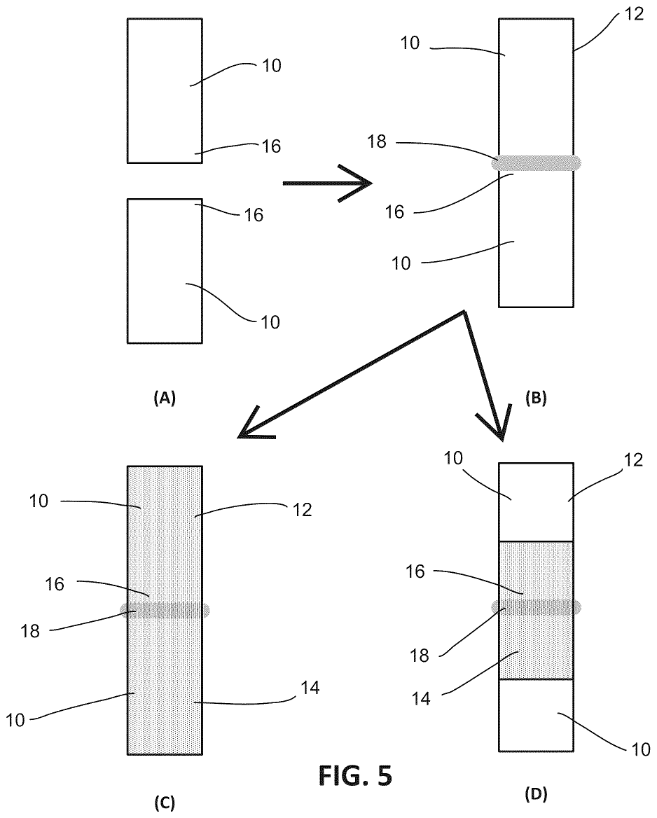

A method for joining two pieces to form a base object is also disclosed herein, and embodiments of such a method are illustrated in FIGS. 5-7. It is understood that FIGS. 5-7 all illustrate joining of two pieces, but that similar methods may be used for joining any number of pieces. In general, the two or more pieces 10 may be joined together, e.g., using welding or another integral joining technique, to form the base object 12, and a coating 14 as disclosed herein may be formed on the base object 12 and/or the pieces 10 before and/or after joining by application of a slurry coating composition. The coating 14 may be applied to at least an area 16 surrounding the joint 18 formed between the pieces in one embodiment, and may be applied to partially or completely surround or cover the joint 18. FIG. 5 illustrates one embodiment of a joining method, where two pieces 10, at FIG. 5A are joined using an integral joining technique (e.g., welding) at FIG. 5B to form a base object 12, and subsequently, the areas 16 surrounding the joint 18 (including the joint 18 itself) are coated by applying a coating composition to form a coating 14 as disclosed herein, at FIG. 5C-D. The coating 14 may be formed on at least a portion of the outer surface of the base object 12, such as coating the entire base object 12 as shown in FIG. 5C, or only a portion of the base object 12, which may include the areas 16 surrounding the joint 18, as shown in FIG. 5D.

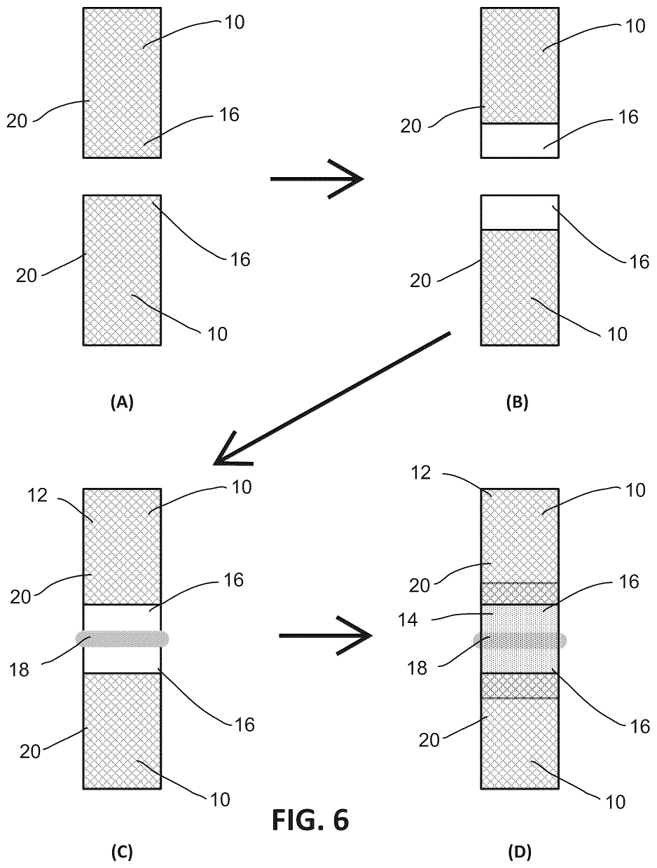

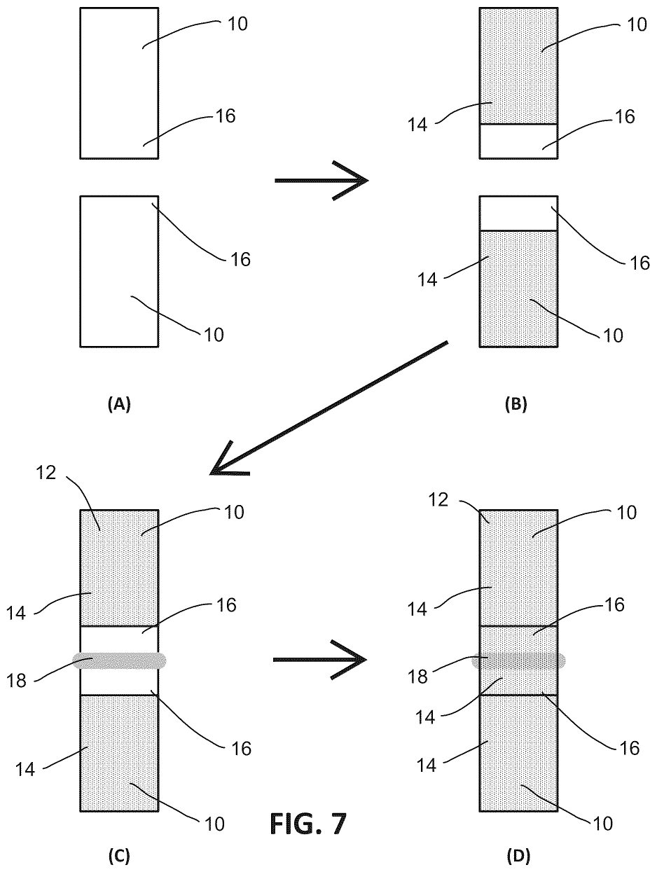

In one embodiment, part or all of the pieces 10 that are joined together may be coated with a preexisting coating 20 prior to joining, such as shown in FIG. 6. Joining of the pieces 10 may be accomplished with or without removing of the preexisting coating 20, and it is understood that removal of at least part of the preexisting coating 20 may be required if the preexisting coating 20 covers the areas 16 to be joined. FIG. 6 illustrates an embodiment of joining of two such pieces 10, at FIG. 6A, where at least part of the preexisting coating 20 is removed (at FIG. 6B) in the areas 16 around the joint 18 prior to joining at FIG. 6C. The coating composition as disclosed herein may be applied at FIG. 6D to repair the preexisting coating 20 and/or to coat portions of the base object that have become uncoated during the joining process. The coating 14 in FIG. 6 covers both the areas 16 around the joint 18 and a portion of the preexisting coating 20, as well as the joint 18 itself. In another embodiment, the areas 16 of the pieces 10 that are joined together are uncoated prior to joining, e.g., due to the piece 10 not being coated or having an incomplete preexisting coating 20. As disclosed herein, an incomplete preexisting coating 20 may be achieved by partial removal of the preexisting coating 20 in some embodiments (e.g., as in FIG. 6), such as by machining, abrasion, or other mechanical removal techniques, or by incomplete application of a coating (e.g., as in FIG. 7). The joined pieces 10 may be formed of similar or identical materials in one embodiment, or at least the joined portions of the pieces 10 may be formed of similar or identical materials. It is understood that the base object 12 may be subjected to additional processing steps subsequent to joining and before application of the coating in some embodiments.

In another embodiment, the coating 14 may be formed on the piece(s) 20 before joining, i.e., by applying the slurry to one or more of the pieces 20 to be joined, and then subsequently joining the pieces to form the base object 12 as disclosed herein. The coating 14 may not be applied to the area 16 to be joined in one embodiment, such that the joint 18 is formed at the area 16 not coated by a coating 14 as disclosed herein. Some or all of the remaining surface of the piece(s) 10 may be coated prior to joining. In this configuration, the slurry may also be applied after joining to form a coating 14 on a previously-uncoated portion of the base object 12, e.g., areas 16 around the joint. FIG. 7 illustrates one embodiment of a joining method for joining two pieces 10 (FIG. 7A), where the coating composition is applied at FIG. 7B to form a partial coating 14 on two pieces 10 prior to joining, at FIG. 7C. The partial coating 14 does not cover the areas 16 around the joint 18 in FIG. 7. Subsequent to joining, the areas 16 around the joint 18 (including the joint 18 itself) are coated at FIG. 7D by applying the coating composition to form the coating 14 as disclosed herein. In an alternate embodiment, the coating may be applied to the area to be joined (e.g., by applying locally or to the entire piece), such that the joint is formed at an area coated by a coating disclosed herein.

For a more complete understanding of the present disclosure, the following are non-limiting illustrative examples of a silicide slurry prepared and applied in accordance herewith. In the examples, all parts are by weight absent indications to the contrary.

### Example 1

A silicide slurry was prepared by admixing together in a suitable vessel equipped with agitation means, a mixture of toluene, methyl ethyl ketone, chromium powder, silicon powder and isobutyl methacrylate. The ingredients were mixed slowly together for a period of about 120 minutes to form a thickened slurry. The result was a thickened brush-on slurry. The slurry had the following composition:

TABLE 1

| Ingredient | Amount, pbw |
|---|---|
| Toluene | 120 |
| Methyl Ethyl Ketone | 20 |
| Isobutyl Methacrylate | 30 |
| Silicon Powder | 200 |
| Chromium Powder | 50 |

### Example 2

The procedure of Example 1 was repeated, except that the following ingredients and amounts were used:

TABLE 2

| Ingredient | Amount, pbw |
|---|---|
| Toluene | 150 |
| Isobutyl Methacrylate | 30 |
| Fumed Silica | 200 |
| Chromium Powder | 50 |

To test the efficacy of the silicide slurries prepared in Examples 1 and 2, a pair of niobium C103 coupons were prepared. The silicide slurry of Example 1 was brushed onto one coupon and the slurry of Example 2 was brushed onto the second coupon. Each coated coupon was allowed to dry on the coupons for about 24 hours. Thereafter, using a MAPP gas torch, each coupon was heated to a glowing, red-hot temperature and then allowed to cool to room temperature. For each coating, the applied layer was cleaned using a wire brush then reheated again to a glowing, red-hot temperature of about 1590 °C. After cooling, each coupon was cleaned in an ultrasonic cleaner to enable evaluation of the surface. The results of the evaluation are set forth below, as shown in the Figures as described below.

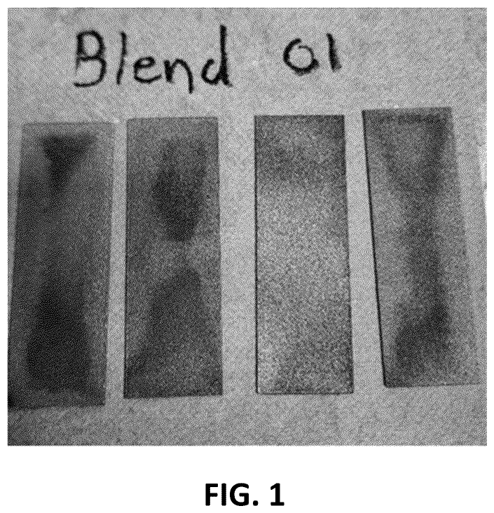

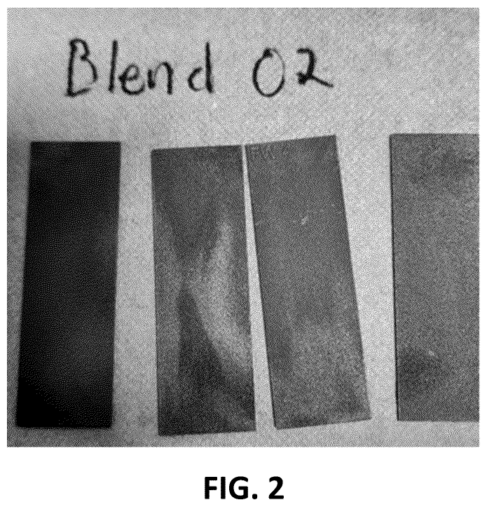

FIGS. 1 and 2 are photographs of the surface discoloration post treatment for each coating blend, respectively. Discoloration of the surface was visually more apparent on blend 2 as opposed to blend 1, but both evidence utility.

Although each blend precluded the oxidation sought to be achieved, blend 1 was more effective.

To further test the efficacy, the coupon of blend 1 was sectioned and mounted in an epoxy so that a cross-section of the coupon could be evaluated.

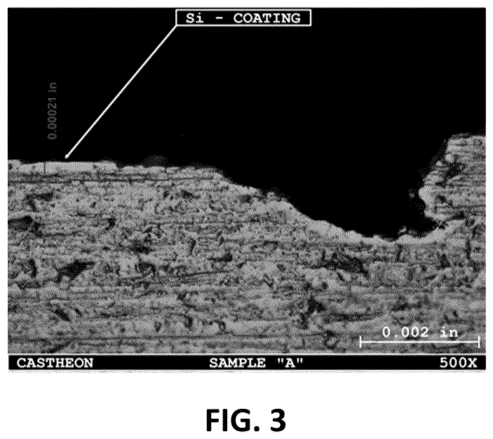

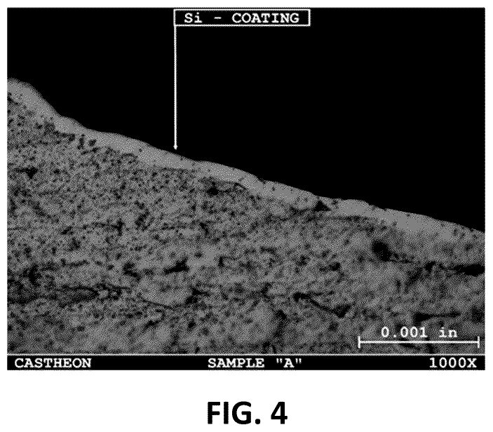

The coupon was ground and polished to expose the reaction region at the surface. Using light microscopy at 500× and 1000×, the sample was evaluated. FIGS. 3 and 4 show the results of the microscopy analysis after slurry deposition. The region of the niobium C103 surface and the slurry surface is shown to be continuous with substantially no discontinuities.

Various embodiments of coatings, methods, and coated objects have been described herein, which include various components and features. In other embodiments, the coatings, methods, and/or coated objects may be provided with any combination of such components and features. It is also understood that in other embodiments, the various devices, components, and features of the coatings, methods, and coated objects described herein may be constructed with similar structural and functional elements having different configurations, including different ornamental appearances.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the spirit or central characteristics thereof. The present examples and embodiments, therefore, are to be considered in all respects as illustrative and not restrictive, and the invention is not to be limited to the details given herein. Nothing in this specification should be construed as requiring a specific three dimensional orientation of structures in order to fall within the scope of this invention, unless explicitly specified by the claims. When used in description of a method or process, the term “providing” (or variations thereof) as used herein means generally making an article available for further actions, and does not imply that the entity “providing” the article manufactured, assembled, or otherwise produced the article. The terms “about” or “approximately” as used herein implies a variation of up to 10% of the nominal value or property modified by such term, or up to 10% of a midpoint value of a range modified by such term. “Integral joining technique,” as used herein, means a technique for joining two pieces so that the two pieces effectively become a single, integral piece, including, but not limited to, irreversible joining techniques such as welding, brazing, soldering, or the like, where separation of the joined pieces cannot be accomplished without structural damage thereto. Accordingly, while the specific embodiments have been illustrated and described, numerous modifications come to mind without significantly departing from the spirit of the invention and the scope of protection is only limited by the scope of the accompanying claims.

What is claimed is:

1. An coating composition for application to a high temperature refractory alloy object, consisting essentially of:
(a) an aromatic solvent;
(b) a silicon-based powder; and
(c) an acrylate-based adhesive, wherein the aromatic solvent, the silicon-based powder, and the acrylate-based adhesive are mixed together to form a slurry for application to the high temperature refractory alloy object by brushing thereon to form an oxidation-inhibiting coating.

2. The coating composition of claim 1, wherein:
(a) the aromatic solvent is present in an amount of from about 40 to about 55 percent, by weight, based on an entire weight of the composition of the silicon-based powder;
(b) the silicon-based powder is present in an amount of from about 40 to about 60 percent, by weight, based on the entire weight of the composition; and
(c) the adhesive is present in an amount of from about 5 to about 20 percent, by weight, based on the entire weight of the composition.

3. The coating composition of claim 2, wherein:
(a) the solvent is selected from the group consisting of benzene, toluene and xylene;
(b) the silicon-based powder is selected from the group consisting of a silicide powder, a fumed silica powder, and a fused silica powder; and
(c ) the adhesive is isobutyl acrylate.

4. The coating composition of claim 1 wherein the solvent includes a ketone solvent.

5. A high temperature refractory alloy object comprising:
a base object formed of a niobium refractory alloy, the base object having an outer surface; and
a silicide coating on at least a portion of the outer surface the silicide coating being formed by brushing a coating composition onto the outer surface and drying the coating composition, the coating composition comprising:
(a) an aromatic solvent;
(b) a silicon-based powder; and
(c) an acrylate-based adhesive.

6. The object of claim 5, wherein:
(a) the solvent is selected from the group consisting of benzene, toluene and xylene;
(b) the silicon-based powder is selected from the group consisting of a silicide powder, a fumed silica powder, and a fused silica powder; and
(c) the adhesive is isobutyl acrylate.

7. A method for resisting oxidation of a high temperature refractory alloy object, comprising:
applying a coating composition to at least a portion of an outer surface of a base object comprising a high temperature refractory alloy, the coating composition comprising:
(a) an aromatic solvent;
(b) a silicon-based powder; and
(c) an adhesive; and
drying the coating composition on the outer surface of the base object to form a coated base object having a silicide coating on the at least a portion of the outer surface,
wherein the silicide coating is an oxidation-resistant coating to resist oxidation of the high temperature refractory alloy.

8. The method of claim 7, wherein:
(a) the solvent is selected from the group consisting of benzene, toluene and xylene;
(b) the silicon-based powder is selected from the group consisting of a silicide powder, a fused silica, and a fumed silica; and
(c ) the adhesive is isobutyl acrylate.

9. The method of claim 8, wherein the high temperature refractory alloy is a niobium or hafnium carbide high temperature refractory alloy.

10. The method of claim 7, further comprising:
forming the base object, prior to applying the coating composition, by joining a first piece and a second piece together at a joint using an integral joining technique, wherein the at least a portion of the outer surface of the base object comprises an area surrounding the joint.

11. The method of claim 10, wherein at least one of the first piece and the second piece has a preexisting coating prior to the joining, and wherein the coating composition is applied to an uncovered portion of the at least one of the first piece and the second piece that is not covered by the preexisting coating.

12. The method of claim 11, wherein the coating composition is applied to at least partially cover the preexisting coating on the at least one of the first piece and the second piece.

13. The method of claim 11, further comprising removing at least a portion of the preexisting coating on the at least one of the first piece and the second piece to create the uncovered portion, prior to applying the coating composition.

14. The method of claim 7, wherein the outer surface of the base object comprises a preexisting coating prior to applying the coating composition, and wherein the coating composition is applied to repair at least a portion of the preexisting coating.

15. The method of claim 7, wherein the solvent is an aromatic solvent, and the adhesive is an acrylate-based adhesive.

16. The method of claim 7, wherein the coating composition is a slurry and is applied by brushing the slurry onto the at least a portion of the outer surface.

17. The method of claim 7, wherein the coating composition is a slurry and is applied by immersing the at least a portion of the outer surface into the slurry.

18. The method of claim 7, further comprising, after drying the coating composition, heating the object at a temperature of up to about 1600 °C.

19. The method of claim 7, wherein the base object is an aerospace part.
